(19) United States
(12) Patent Application Publication
(10) Pub. No.: US 2008/0264279 A1
(43) Pub. Date: Oct. 30, 2008

(54) Sheeter apparatus

(75) Inventors: You Shimizu, Tsukuba-shi (JP); Koichi Ohrui, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION

(21) Appl. No.: 12/078,618

(22) Filed: Apr. 2, 2008

(30) Foreign Application Priority Data
Apr. 24, 2007 (JP) 2007-113629

(51) Int. Cl. B41F 13/56

(52) U.S. Cl. 101/227

(57) ABSTRACT

A sheeter apparatus includes: a cutter cylinder for cutting a transported web into sheets in cooperation with a fixed knife; lower high-speed transportation belts for transporting a cut sheet; and a suction device for sucking the cut sheet from suction ports of a suction roller, which causes the lower high-speed transportation belts to travel, in such a manner that a surface of the sheet which is on the other side of the surface facing the cutter cylinder adheres to the outer peripheral surface of the suction roller.

### BACKGROUND OF THE INVENTION

1. Field of the Invention

The present invention relates to a sheeter apparatus for cutting a printed web which is dried and cooled after its printing into sheets, each with a predetermined length, and for thereafter piling the resultant sheets while evening up the edges of the sheets.

2. Description of the Related Art

Web rotary printing presses are each provided with a sheeter apparatus for cutting a printed web which is dried and cooled after its printing into sheets, each with a predetermined length, and for thereafter piling the resultant sheets while evening up the edges of the sheets. This type of sheeter apparatus is designed to cut a transported web into sheets between a cutting knife of a rotary cutter cylinder (cut-off cylinder) and a fixed knife, and subsequently to deliver the sheets to the inside of a frame arranged on a pile board by use of transport belts and the like.

As the cutting knife of the cutter cylinder and the fixed knife become dull, the cutting knife rotates while curling up sheets at their rear ends, which are cutting positions of the cutting knife, with a revolution of the cutter cylinder. In addition, the continuous cutting of the transported web with the cutter cylinder easily causes static electricity on its outer peripheral surface and the cutter cylinder. This static electricity sticks the rear ends of the sheets to the cutter cylinder. Curl-up of sheets at their rear ends and the sticking of the rear ends of the sheets to the cutter cylinder are termed as absorption. Once the absorption takes place, sheets may wave to make their sheet trails unstable, so that the sheet trails may be folded over. This is likely to lead not only to deterioration in quality of printed matters, but also to damage on the apparatus.

With this taken into consideration, there have been provided various types of sheeter apparatuses, each adopting preventive measures against the absorption of sheets to the cutter cylinder which occurs while the cutter cylinder is cutting a transported web into the sheets. One of these conventional types of sheeter apparatuses is disclosed, for example, in Japanese Examined Utility Model Publication No. Hei. 7-11911.

### SUMMARY OF THE INVENTION

The sheeter apparatus of the foregoing conventional type is designed to eject air from the outer peripheral surface of the rotary cutter cylinder outward in the radial direction of the cutter cylinder. Thereby, the sheeter apparatus of the conventional type prevents the absorption of cut sheets to the cutter cylinder which would otherwise occur.

However, this configuration ejects air to sheets from upstream in a direction of transporting the sheets (hereinafter referred to as a “sheet transportation direction”) while the sheets are being transported after being cut. The configuration accordingly causes part of the air to go under the rear ends of the sheets. As a result, sheet trails are blown up, and the sheets are transported in an unstable condition.

In addition, the constant ejection of air from the rotary cutter cylinder can push cut sheets, which are arranged downstream of the cutting positions in the sheet transportation direction, as described above, but also pushes back a web which is arranged upstream of the cutting position in the sheet transportation direction. As a result, the web is transported in an unstable condition. Accordingly, the cutting position of the web varies in some cases, and this variation makes it likely that cut sheets may not have a single predetermined length.

The present invention has been made for the purpose of solving the foregoing problems. An object of the present invention is to provide a sheeter apparatus capable of preventing the absorption of cut sheets to its cutter cylinder without adversely affecting transportation of the web or the sheets.

A sheeter apparatus according to a first aspect of the present invention for the purpose of solving the foregoing problems comprises: cutting means configured to cut a transported web into sheets; transportation means configured to transport the sheets into which the cutting means cuts the web; and suction means provided in a vicinity of the transportation means, and configured to suck the sheets which are going to be transported by the transportation means, thereby moving the sheets toward the transportation means.

A sheeter apparatus according to a second aspect of the present invention provides the sheeter apparatus according to the first aspect of the present invention, wherein the cutting means includes a cut-off cylinder for cutting the web into the sheets, the web being transported by revolution of the cut-off cylinder, and wherein the suction means sucks a back surface of each sheet, the back surface being on the other side of the surface which faces the cut-off cylinder.

A sheeter apparatus according to a third aspect of the present invention provides the sheeter apparatus according to the first aspect of the present invention, wherein the transportation means includes belts for transporting the sheets, and rollers for causing the belts to travel, and wherein the suction means sucks each sheet from suction ports formed in the outer peripheral surface of one of the rollers.

A sheeter apparatus according to a fourth aspect of the present invention provides the sheeter apparatus according to the first aspect of the present invention, wherein the transportation means is belts for transporting the sheets, and wherein the suction means sucks each sheet, via belt holes of the belts, from suction ports formed in a sliding contact surface with which the belts comes into a sliding contact.

A sheeter apparatus according to a fifth aspect of the present invention provides the sheeter apparatus according to the first aspect of the present invention, wherein the transportation means includes belts for transporting the sheets and a plurality of rollers which have the belts hooked therearound to cause the belts to travel, and wherein the suction means is one of the plurality of rollers that is located at the uppermost-stream side in a sheet transportation direction.

A sheeter apparatus according to a sixth aspect of the present invention provides the sheeter apparatus according to the third aspect of the present invention, wherein the suction ports are formed in parts of the outer peripheral surface of one of the rollers which no belts are hooked around.

A sheeter apparatus according to a seventh aspect of the present invention provides the sheeter apparatus according to the sixth aspect of the present invention, wherein the roller includes groove parts which are formed to extend in a circumferential direction of the roller, and wherein the belts are hooked around the groove parts.

A sheeter apparatus according to an eighth aspect of the present invention provides the sheeter apparatus according to the third aspect of the present invention, wherein the roller includes: a suction path which is formed in the same direction as an axis of the roller extends, and which is connected to a suction device with a rotary joint in between; and communicating paths which communicate with the suction path, and which are connected to the respective suction ports.

A sheeter apparatus according to a ninth aspect of the present invention provides the sheeter apparatus according to the first aspect of the present invention, wherein the transportation means includes: belts for transporting the sheets; and a plurality of rollers which have the belts hooked therearound to cause the belts to travel, and wherein the suction means is provided inside loops formed by the belts hooked around the plurality of rollers.

A sheeter apparatus according to a tenth aspect of the present invention provides the sheeter apparatus according to the ninth aspect of the present invention, wherein the suction means is a suction box including suction ports connected to a suction device.

A sheeter apparatus according to an eleventh aspect of the present invention provides the sheeter apparatus according to the first aspect of the present invention, wherein the cutting means includes: a cut-off cylinder which is revolvably supported, and which has cutting knives; and a fixed knife, and wherein the transported web is cut into the sheets when the cutting knives face the fixed knife with revolution of the cut-off cylinder.

A sheeter apparatus according to a twelfth aspect of the present invention provides the sheeter apparatus according to the first aspect of the present invention, wherein the transportation means includes: upstream transportation means configured to transport the sheets; and downstream transportation means configured to receive the sheets from the upstream transportation means and then to transport the received sheets at a speed lower than the upstream transportation means.

The sheeter apparatus according to the present invention is capable of preventing the absorption of cut sheets to its cutting means, because the sheeter apparatus sucks the cut sheets by use of its suction means immediately after the web is cut into the sheets. In addition, the sheeter apparatus is capable of stably transporting the sheets while preventing unstable behavior of the sheets, because the sheeter apparatus is capable of transporting the sheets while putting the sheets in a close contact with the suction means through by the suction. Furthermore, the sheeter apparatus is capable of stably transporting the web, and is accordingly capable of cutting the web in a stable condition. This is because the sheeter apparatus applies the suction operation to the sheets only so that the suction operation causes no influence on the web.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is an overall schematic diagram of the sheeter apparatus according to a first embodiment of the present invention;

FIG. 2 is a diagram showing a chief part of the sheeter apparatus shown in FIG. 1 in a magnified manner;

FIG. 3 is a plan view of the chief part of the sheeter apparatus shown in FIG. 2;

FIG. 4 is a diagram showing a chief part of a sheeter apparatus according to a second embodiment of the present invention in a magnified manner; and

FIG. 5 is a plan view of the chief part of the sheeter apparatus shown in FIG. 4.

### DETAILED DESCRIPTION OF THE INVENTION

Descriptions will be provided hereinbelow for sheeter apparatuses according to the present invention.

### FIRST EMBODIMENT

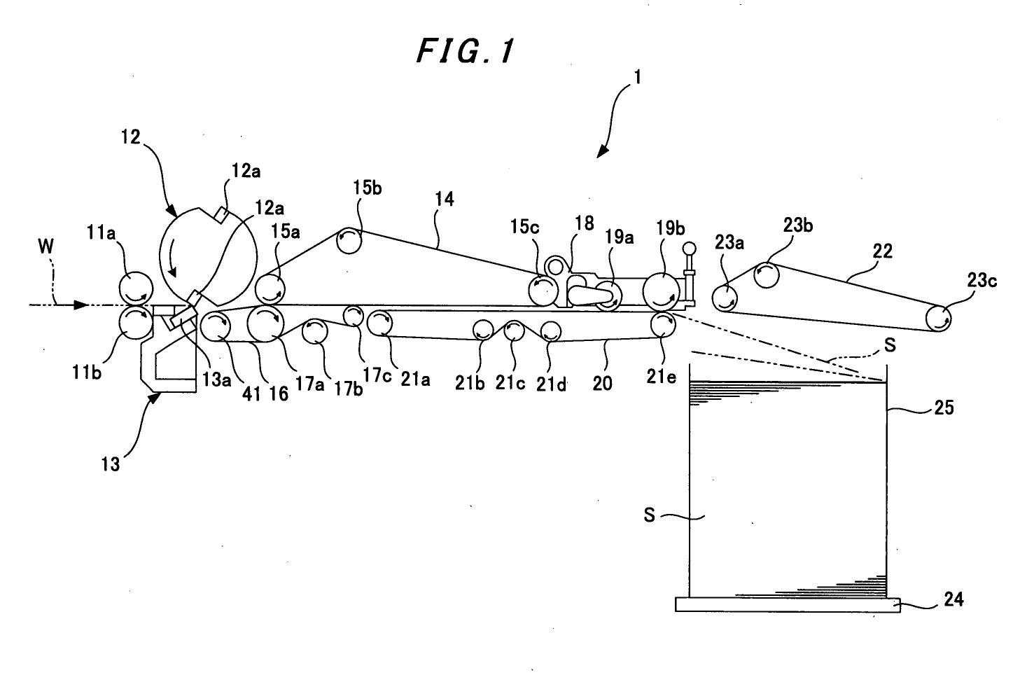

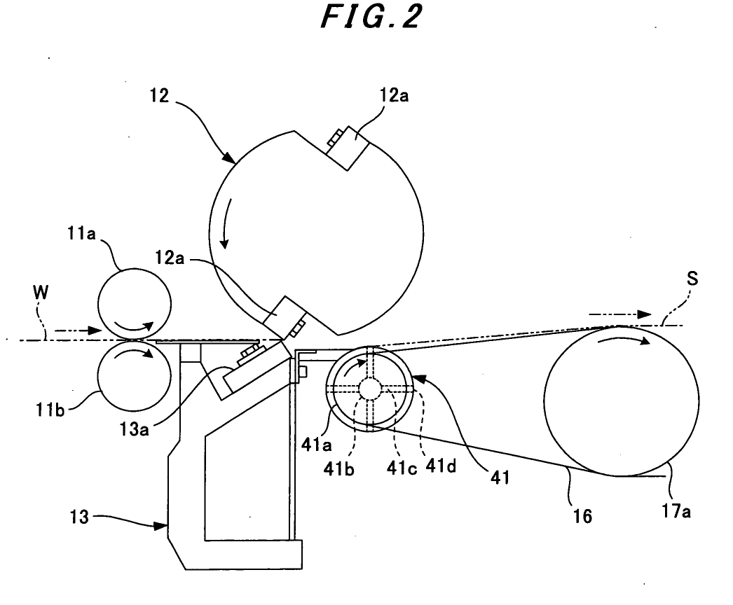

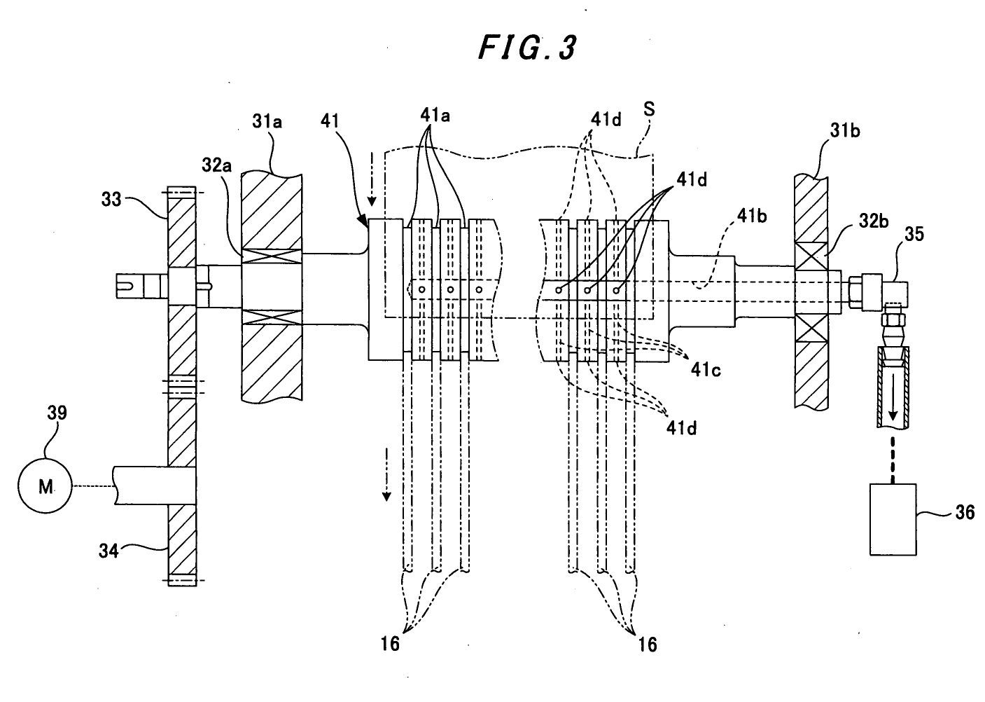

FIG. 1 is an overall schematic diagram of a sheeter apparatus according to a first embodiment of the present invention. FIG. 2 is an enlarged diagram of a chief part of the sheeter apparatus shown in FIG. 1, and FIG. 3 is a plan view of the chief part of the sheeter apparatus shown in FIG. 2.

A web rotary printing press, which is not illustrated, includes a sheeter apparatus 1 as shown in FIG. 1. The sheeter apparatus is configured to cut a printed web W which is dried and cooled after its printing into sheets S, each with a predetermined length, and thereafter to pile the resultant sheets while evening up the edges of the sheets.

The sheeter apparatus 1 includes paired nipping rollers 11a and 11b revolvably supported in its upstream position in a direction in which a web is transported (hereinafter referred to as a “web transportation direction). The nipping rollers 11a and 11b are arranged opposite to each other vertically in order that the nipping rollers can nip the web which is being transported. In a position downstream of the nipping rollers 11a and 11b in the web transportation direction, a cutter cylinder (cut-off cylinder) 12 is revolvably supported above the transported web W, whereas a fixed base 13 is provided under the transported web W.

As shown in FIGS. 1 and 2, the cutter cylinder 12 is provided with cutting knives 12a in its outer peripheral portion. The cutting knives 12a are placed there at equal intervals (at intervals of 180 degrees in the case shown in FIGS. 1 and 2) in the circumferential direction of the cutter cylinder 12. Each of the cutting knives 12a extends in the same direction as the axis of the cutter cylinder 12 extends. On the other hand, a fixed knife 13a is provided in an upper portion of the fixed base 13. In other words, while the cutter cylinder 12 is revolving, the cutting knives 12a of the cutter cylinder 12 come into contact with the fixed knife 13a of the fixed base 13. This contact makes it possible to continuously cut the transported web W in a predetermined length, and accordingly to form the sheets S. It should be noted that the cutter cylinder 12 and the fixed base 13 constitute cut-off means.

In a position downstream of the cutter cylinder 12 in the sheet transportation direction, multiple upper high-speed transportation belts 14 are hooked around upper high-speed driving rollers 15a, 15b and 15c. On the other hand, in a position downstream of the fixed base 13 in the sheet transportation direction, multiple lower high-speed transportation belts 16 are hooked around lower high-speed driving rollers 17a, 17b and 17c as well as a suction roller 41 (see FIG. 3). While running in the lower side, the lower surfaces of the upper high-speed transportation belts 14 are respectively in contact with the upper surfaces of the lower high-speed transportation belts 16 which are running in the upper level. The revolutionary driving of all the upper high-speed driving rollers 15a, 15b and 15c and the lower high-speed driving rollers 17a, 17b and 17c causes the sheets S to be transported while held between the lower surfaces of the upper high-speed transportation belts 14 and the upper surfaces of the lower high-speed transportation belts 16, where the two kinds of belts 14 and 16 face each other.

Furthermore, an upper low-speed transportation device 18 is provided in a position downstream of the upper high-speed transportation belts 14 in the sheet transportation direction. The upper low-speed transportation device 18 revolvably supports upper low-speed transportation rollers 19a and 19b which are revolutionarily driven by the upper low-speed transportation device 18. On the other hand, in a position downstream of the lower high-speed transportation belts 16 in the sheet transportation direction, multiple lower low-speed transportation belts 20 are hooked around lower low-speed driving rollers 21a, 21b, 21c, 21d, and 21e. The outer peripheral surfaces of the upper low-speed transportation rollers 19a and 19b are respectively in contact with the upper surfaces of the lower low-speed transportation belts 20 which are running in the upper level. The revolutionary driving of all the upper low-speed transportation rollers 19a and 19b and the lower low-speed driving rollers 21a, 21b, 21c, 21d and 21e causes the sheets S to be transported while held between the outer peripheral surfaces of the upper low-speed transportation rollers 19a and 19b and the upper surfaces of the lower low-speed driving rollers 21a, 21b, 21c, 21d and 21e, where the rollers 19a and 19b face the rollers 21a, 21b, 21c, 21d and 21e.

It should be noted that the revolutionary speeds respectively of the upper high-speed driving rollers 15a, 15b and 15c, the lower high-speed driving rollers 17a, 17b and 17c as well as the suction roller 41 are set almost equal to one another, and that the revolutionary speeds respectively of the upper low-speed transportation rollers 19a and 19b as well as the lower low-speed driving rollers 21a, 21b, 21c, 21d and 21e are also set almost equal to one another. Furthermore, the revolutionary speeds respectively of the upper high-speed driving rollers 15a, 15b and 15c, the lower high-speed driving rollers 17a, 17b and 17c as well as the suction roller 41 are set higher than that respectively of the upper low-speed transportation rollers 19a and 19b as well as the lower low-speed driving rollers 21a, 21b, 21c, 21d and 21e.

In other words, the sheets S are transported at the high speed between the upper high-speed transportation belts 14 and the lower high-speed transportation belts 16, and thereafter are transported at the low speed between the upper low-speed transportation rollers 19a and 19b and the lower low-speed transportation belts 20. In addition, the upper high-speed transportation belts 14, the upper high-speed driving rollers 15a, 15b and 15c, the lower high-speed transportation belts 16, the lower high-speed driving rollers 17a, 17b and 17c, the upper low-speed transportation device 18, the upper low-speed transportation rollers 19a and 19b, the lower low-speed transportation belts 20, the lower low-speed driving rollers 21a, 21b, 21c, 21d and 21e as well as the suction roller 41 constitute transportation means.

Moreover, in a position downstream of the upper low-speed transportation device 18 in the sheet transportation direction, multiple guide belts 22 are hooked around driving rollers 23a, 23b and 23c. A pile board 24 is provided under the guide belts 22, and a frame 25 for piling sheets is mounted on this pile board 24.

Descriptions will be provided next for a supporting structure of the suction roller 41 by use of FIGS. 2 and 3.

As shown in FIGS. 2 and 3, the suction roller 41 is revolvably supported by frames 31a and 31b of the sheeter apparatus 1 by use of bearings 32a and 32b. A driving gear 33 is provided in one end of the suction roller 41. An output gear 34 revolutionarily driven by drive of a driving motor 39 meshes with this driving gear 33. A suction device 36 is connected to the other end of the suction roller 41 with a rotary joint 35 being interposed in between.

Multiple groove parts 41a are formed in the outer peripheral surface of the suction roller 41 in such a way that the groove parts 41a extend throughout the circumference of the suction roller 41. The lower high-speed transportation belts 16 are hooked around these groove parts 41a. It should be noted that, as shown in FIG. 2, the groove parts 41a are formed with a depth which causes the outer surfaces respectively of the lower high-speed transportation belts 16 thus hooked to be arranged inward of the outer peripheral surface of the suction roller 41 in the radial direction of the suction roller 41.

In addition, a suction path 41b is formed in the suction roller 41 in such a way that the suction path 41b is arranged coaxially with the center axis. One end of the suction path 41b communicates with the suction device 36 with the rotary joint 35 interposed in between. Suction ports 41d are formed in the outer peripheral surface of the suction roller 41 in such a way that the suction ports 41d are open to the outer peripheral surface at equal intervals (at intervals of 90 degrees in the case shown in FIG. 3) in the circumferential direction of the suction roller 41. Communicating paths 41c radially extending from the suction path 41b communicate with these suction ports 41d, respectively. It should be noted that the rotary joint 35, the suction device 36, and the suction roller 41 constitute suction means.

In other words, the revolution obtained a the drive of the driving motor 39 is transmitted to the driving gear 33 via the output gear 34, and thereby the suction roller 41 is caused to revolve. Concurrently, the suction device 36 is caused to operate. This makes it possible for the suction roller 41 to suck the cut sheets S from the suction ports 41d by use of the communicating paths 41c, the suction path 41b and the rotary joint 35.

In sum, the foregoing configuration causes the printed web W which is cooled and dried after the printing to be transported into the sheeter apparatus by use of the paired nipping rollers 11a and 11b. Once the web W thus transported is further transported in the interstice between the revolutionarily driving cutter cylinder 12 and the fixed base 13, the cutting knives 12a of the cutter cylinder 12 and the fixed knife 13a of the fixed base 13 cut the web W with the predetermined length, and accordingly forms the sheets S, in cooperation between the cutting knives 12a and the fixed knife 13a. Thereafter, the front end of each sheet S is held between the upper high-speed transportation belts 14 and the lower high-speed transportation belts 16 at the same time as the sheet S is cut from the web. Thereby, the sheet S is transported at high speed by travels of the upper high-speed transportation belts 14 and the lower low-speed transportation belts 16.

At this time, the suction roller 41 is revolved by the drive of the driving motor 39, and concurrently, by the operation of the suction apparatus 36, the suction roller 41 sucks each cut sheet S along its front end in its surface which is on the other side of the surface facing the cutter cylinder 12 by use of the suction path 41b, the communicating paths 41c and the suction ports 41d. Thereby, while the surface of the cut sheet S which is on the other side of the surface facing the cutter cylinder 12 is in close contact with the outer peripheral surface of the suction roller 41, the cut sheet S enters the interstice between the upper high-speed transportation belts 14 and the lower high-speed transportation belts 16, and is subsequently transported at high speed.

As a result, the sheeter apparatus prevents the roll up or the adherence of the rear ends of the respective sheets S toward or to the cutter cylinder 12. That is, the absorption is prevented. In addition, because the sheeter apparatus according to this embodiment does not blow up the trail edges of the sheets S, the sheets S are stably transported at high speed. Concurrently, the web W is also stably transported because the sheeter apparatus applies this suction operation to the sheets S only so that the suction operation causes no influence on the web W.

Subsequently to their high-speed transportation, the sheets S are transferred to the interstice between the upper low-speed transportation rollers 19a and 19b and the lower low-speed transportation belts 20. Once the sheets S are held between the upper low-speed transportation rollers 19a and 19b and the lower low-speed transportation belts 20 in this manner, the sheets S are transported at low speed instead of at high speed by the revolutionary drives respectively of the upper low-speed transportation rollers 19a and 19b as well as the travels respectively of the lower low-speed transportation belts 20. Furthermore, when the sheets S are transferred to the interstice between the upper low-speed transportation rollers 19a and 19b and the lower low-speed transportation belts 20, the front end of each sheet S which has been transported at high speed while being held between the upper high-speed transportation belts 14 and the lower high-speed transportation belts 16 goes above, and partially overlaps, the rear end of its corresponding preceding sheet S which is transported at low speed while held between the upper low-speed transportation roller 19a and 19b and the lower low-speed transportation belts 20.

Subsequently, the sheets S thus overlapping each other are delivered from the interstice between the upper low-speed transportation rollers 19a and 19b and the lower low-speed transportation belts 20. The sheets S thus delivered fall downward while being guided by the guide belts 22 which are traveling, and are thus sequentially contained inside the frame 25 arranged on the pile board 24 while being aligned by the edges thereof with sheets already in the frame.

In sum, the sheeter apparatus according to the present embodiment is capable of preventing the absorption of the sheets S to the cutter cylinder 12, because the sheeter apparatus causes the suction roller 41, around which the lower high-speed transportation belts 16 are hooked, to suck, from the suction ports 41d of the suction roller 41 by use of the suction device 36, the sheets S which are formed by cutting the web W in cooperation between the cutting knives 12a of the cutter cylinder 12 and the fixed knife 13a of the fixed base 13.

In addition, the sheeter apparatus according to the present embodiment is capable of causing the sheets S to enter the interstice between the upper high-speed transportation belts 14 and the lower high-speed transportation belts 16 while adhering one surface of each sheet S, which is on the other side of the surface facing the cutter cylinder 12, to the outer peripheral surface of the suction roller 41. Thereby, the sheeter apparatus according to the present embodiment is capable of causing the sheets S to be transported at high speed while preventing the sheets S from behaving unstably.

The sheeter apparatus according to the present embodiment is capable of transporting the web W in a stable condition because the sheeter apparatus applies the suction operation to the cut sheets S only so that the suction operation causes no influence on the web W. Thereby, the sheeter apparatus according to the present embodiment is capable of cutting the web W at equal intervals, and thus capable of preventing the cutting positions from varying from one to another, as well as accordingly capable of always forming the sheets S each with a single predetermined length.

### SECOND EMBODIMENT

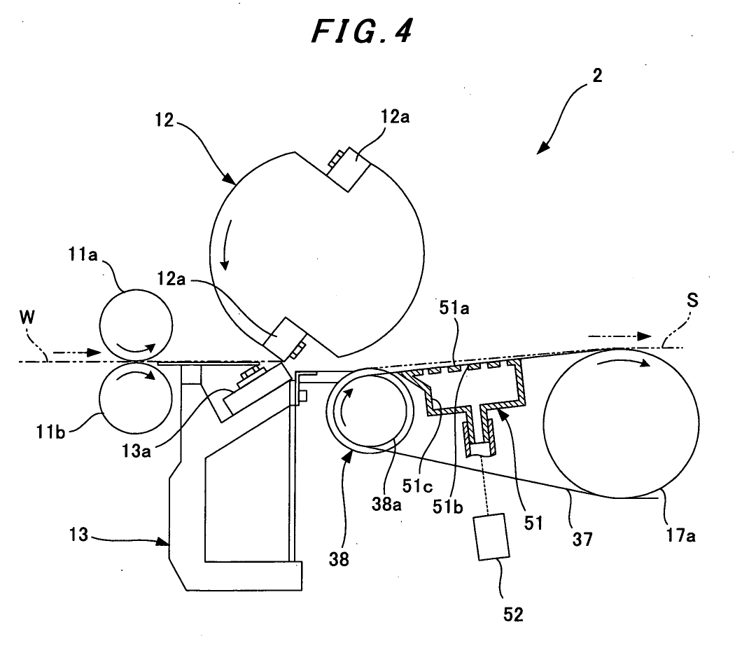

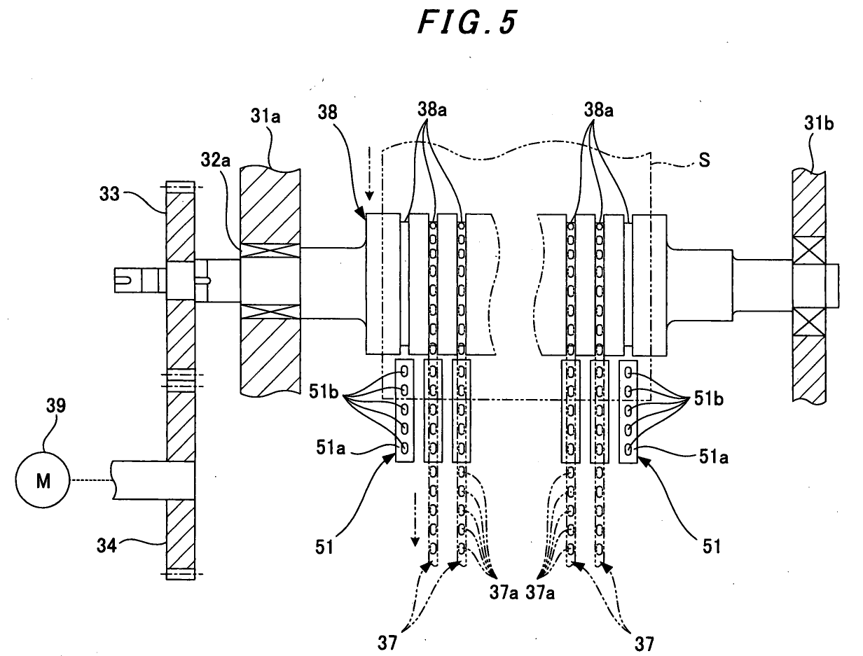

FIG. 4 is an enlarged diagram of a chief part of a sheeter apparatus according to a second embodiment of the present invention in a magnified manner. FIG. 5 is a plan view of the chief part of the sheeter apparatus shown in FIG. 4. Incidentally, members each having the same or similar structure and function as those shown for the sheeter apparatus according to the first embodiment are denoted by the same reference numerals, and the duplicated descriptions will be omitted.

A web rotary printing press, which is not illustrated, includes a sheeter apparatus 2 as shown in FIG. 2 for cutting a printed web W which is dried and cooled after its printing into sheets S each with a predetermined length and subsequently piling the resultant sheets S while evening up the edges of the sheets S.

Multiple lower high-speed transportation belts 37 opposingly contact the upper high-speed transportation belts 14 (see FIG. 1). As shown in FIGS. 4 and 5, the lower high-speed transportation belts 37 are hooked around the lower high-speed driving rollers 17a, 17b and 17c as well as a lower high-speed driving roller 38. Multiple oval belt holes 37a are formed in row in the center portion of each of the lower high-speed transportation belts 37 in its width direction in a such way that the belt holes 37a are arrayed in the longitudinal direction of the lower high-speed transportation belt 35. The longitudinal diameters of the respective belt holes 37a are oriented in the longitudinal direction of the lower high-speed transportation belt 35.

The lower high-speed driving roller 38 is revolvably supported by the frames 31a and 31b of the sheeter apparatus 2 by use of the bearing 32a and 32b, respectively. The driving gear 33 is provided to one end of the lower high-speed driving roller 38. The output gear 34 revolutionarily driven by drive of the driving motor 39 meshes with this driving gear 33.

In addition, multiple groove parts 38a are formed in the outer peripheral surface of the lower high-speed driving roller 38 in such a way that the groove parts 38a extend throughout the circumference of the lower high-speed driving roller 38. The lower high-speed transportation belts 37 are hooked around these groove parts 38a. It should be noted that the groove parts 38a are formed with a depth which causes the outer surfaces respectively of the lower high-speed transportation belts 37 thus hooked to be arranged inward of the outer peripheral surface of the lower high-speed driving roller 38 in the radial direction of the lower high-speed driving roller 38.

Incidentally, the lower high-speed transportation belts 37 hooked around the two outermost groove parts 38a of the lower high-speed driving roller 38 shown in FIG. 5 are omitted from the illustration.

While running in the lower side, the lower surfaces of the upper high-speed transportation belts 14 are respectively in contact with the upper surfaces of the lower high-speed transportation belts 37 which are running in the upper level. The revolutionary driving of all the upper high-speed driving rollers 15a, 15b and 15c, the lower high-speed driving rollers 17a, 17b and 17c, as well as lower high-speed driving roller 38 causes the sheets S to be transported while held between the lower surfaces of the upper high-speed transportation belts 14 and the upper surfaces of the lower high-speed transportation belts 37, where the two kinds of belts 14 and 37 face each other.

It should be noted that the revolutionary speeds respectively of the upper high-speed driving rollers 15a, 15b and 15c, the lower high-speed driving rollers 17a, 17b and 17c as well as the lower high-speed driving roller 38 are set almost equal to one another, and that these revolutionary speeds are set higher than that respectively of the upper low-speed transportation rollers 19a and 19b, the lower low-speed driving rollers 21a, 21b, 21c, 21d and 21e. In other words, the sheets S are transported at high speed between the upper high-speed transportation belts 14 and the lower high-speed transportation belts 37, and thereafter are transported at low speed between the upper low-speed transportation rollers 19a and 19b and the lower low-speed transportation belts 20.

In addition, the upper high-speed transportation belts 14, the upper high-speed driving rollers 15a, 15b and 15c, the lower high-speed driving rollers 17a, 17b and 17c, the upper low-speed transportation device 18, the upper low-speed transportation rollers 19a and 19b, the lower low-speed transportation belts 20, the lower low-speed driving rollers 21a, 21b, 21c 21d and 21e, the lower high-speed transportation belts 37 as well as the lower high-speed driving roller 38 all constitute transportation means.

A suction box 51 is provided in a position under the lower high-speed transportation belts 37 between the lower high-speed driving roller 17a and the lower high-speed driving roller 38. The suction box 51 is shaped like a hollow box formed longer in the sheet transportation direction.

A sliding contact surface 51a is formed in the upper portion of the suction box 51. The lower high-speed belts 37 come into a sliding contact with the sliding contact surface 51a while the lower high-speed belts 37 are traveling. Multiple suction ports 51b are formed in a row in the center portion of the sliding contact surface 51a in its width direction in such a way that the suction ports 51b are arrayed in the longitudinal direction of the sliding contact surface 51a. The longitudinal diameters of the suction ports 51b are oriented in the longitudinal direction of the sliding contact surface 51a. A suction device 52 is connected to a hollow part 51c in the suction box 51. It should be noted that the suction box 51 and the suction device 52 constitute suction means.

In other words, the operation of the suction device 52 causes air in the hollow part 51c in the suction box 51 to be sucked, and thus the inside of the hollow part 51c is put in lower pressure. As a result, while the suction ports 51b of the suction box 51 are facing the belt holes 37a of the lower high-speed transportation belts 37 traveling on the sliding contact surface 51a, the sheeter apparatus 2 is capable of sucking the cut sheets S.

In sum, the foregoing configuration causes the printed web W which is cooled and dried after its printing to be transported into the sheeter apparatus by use of the paired nipping rollers 11a and 11b. Once the web W thus transported is further transported in the interstice between the revolutionarily driving cutter cylinder 12 and the fixed base 13, the cutting knives 12a of the cutter cylinder 12 and the fixed knife 13a of the fixed base 13 cut the web W with the predetermined length, and accordingly forms the sheets S, in cooperation between the cutting knives 12a and the fixed knife 13a. Thereafter, the front end of each sheet S is held between the upper high-speed transportation belts 14 and the lower high-speed transportation belts 37 at the same time as the sheet S is cut from the web. Thereby, the sheet S is transported at high speed by travels of the upper high-speed transportation belts 14 and the lower low-speed transportation belts 37.

At this time, the lower high-speed transportation belts 37 travel on the sliding contact surface 51a of the suction box 51 while holding the sheets S. On the other hand, the operation of the suction device 52 causes the suction box 51 to suck each cut sheet S along its front end in its surface which is on the other side of the surface facing the cutter cylinder 12 by use of the suction ports 51b and the hollow part 51c when the suction ports 51b are facing the belt holes 37a of the lower high-speed transportation belts 37 traveling on the sliding contact surface 51a. Thereby, while the surface of each cut sheet S which is on the other side of the surface facing the cutter cylinder 12 is in a close contact with the outer peripheral surface of the lower high-speed transportation belts 37, the cut sheet S enters the interstice between the upper high-speed transportation belts 14 and the lower high-speed transportation belts 37, and is subsequently transported at high speed.

As a result, the sheeter apparatus according to the present embodiment prevents the roll up and the adherence of the rear ends of the respective sheets S toward and to the cutter cylinder 12. That is, the absorption is prevented. In addition, because the sheeter apparatus according to the present embodiment does not blow up the trail edges of the sheets S, the sheets S are stably transported at high speed. Concurrently, the web W is also stably transported because the sheeter apparatus applies this suction operation to the sheets S only so that the suction operation causes no influence on the web W.

Subsequently to their high-speed transportation, the sheets S are transferred to the interstice between the upper low-speed transportation rollers 19a and 19b and the lower low-speed transportation belts 20. Once the sheets S are held between the upper low-speed transportation rollers 19a and 19b and the lower low-speed transportation belts 20 in this manner, the sheets S are transported at low speed instead of at high speed by the revolutionary drives respectively of the upper low-speed transportation rollers 19a and 19b as well as the travels respectively of the lower low-speed transportation belts 20. Furthermore, when the sheets S are transferred to the interstice between the upper low-speed transportation rollers 19a and 19b and the lower low-speed transportation belts 20, the front end of each sheet S which has been transported at high speed while held between the upper high-speed transportation belts 14 and the lower high-speed transportation belts 37 goes above, and partially overlaps, the rear end of its corresponding preceding sheet S which is transported at low speed while held between the upper low-speed transportation roller 19a and 19b and the lower low-speed transportation belts 20.

Subsequently, the sheets S thus overlapping each other are delivered from the interstice between the upper low-speed transportation rollers 19a and 19b and the lower low-speed transportation belts 20. The sheets S thus delivered fall downward while guided by the guide belts 22 which are traveling, and are thus sequentially contained inside the frame 25 arranged on the pile board 24 while being aligned by the edges thereof with sheets already in the frame 25.

In sum, the sheeter apparatus according to the present embodiment is capable of preventing the absorption of the sheets S to the cutter cylinder 12, because, when the suction ports 51b are facing the belt holes 37a of the lower high-speed transportation belts 37, the sheeter apparatus causes the sliding contact surface 51a of the suction box 51, on which the lower high-speed transportation belts 37 travel, to suck, from the suction ports 51b of the suction box 51 by use of the suction device 52, the sheets S which are formed by cutting the web W in cooperation between the cutting knives 12a of the cutter cylinder 12 and the fixed knife 13a of the fixed base 13.

In addition, the sheeter apparatus according to the present embodiment is capable of causing the sheets S to enter the interstice between the upper high-speed transportation belts 14 and the lower high-speed transportation belts 37 while adhering one surface of each sheet S, which is on the other side of the surface facing the cutter cylinder 12, to the outer peripheral surface of the lower high-speed driving roller 38, by sucking the sheets S by use of the sucking ports 51b of the sucking box 51. Thereby, the sheeter apparatus according to the present embodiment is capable of causing the sheets S to be transported at high speed while preventing the sheets S from behaving unstably.

Furthermore, the sheeter apparatus according to the present embodiment is capable of transporting the web W in a stable condition, because the sheeter apparatus applies the suction operation to the cut sheets S only so that the suction operation causes no influence on the web W. Thereby, the sheeter apparatus according to the present embodiment is capable of cutting the web W at equal intervals, and thus capable of preventing the cutting positions from varying from one to another, as well as accordingly capable of always forming the sheets S each with a single predetermined length.

The present embodiment is applicable to a delivery mechanism of a web rotary printing press, and enables the delivery mechanism to deliver sheets while preventing a subsequent cut sheet from colliding against its preceding cut sheet so that no jam-up takes place.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sheeter apparatus comprising:
cutting means configured to cut a transported web into sheets;
transportation means configured to transport the sheets into which the cutting means cuts the web; and
suction means provided in a vicinity of the transportation means, and configured to suck the sheets which are going to be transported by the transportation means, thereby moving the sheets toward the transportation means.

2. The sheeter apparatus according to claim 1,
wherein the cutting means includes a cut-off cylinder for cutting the web into the sheets, the web being transported by revolution of the cut-off cylinder, and
wherein the suction means sucks a back surface of each sheet, the back surface being on the other side of the surface which faces the cut-off cylinder.

3. The sheeter apparatus according to claim 1,
wherein the transportation means includes belts for transporting the sheets, and rollers for causing the belts to travel, and
wherein the suction means sucks each sheet from suction ports formed in the outer peripheral surface of one of the rollers.

4. The sheeter apparatus according to claim 1,
wherein the transportation means is belts for transporting the sheets, and
wherein the suction means sucks each sheet, via belt holes of the belts, from suction ports formed in a sliding contact surface with which the belts comes into a sliding contact.

5. The sheeter apparatus according to claim 1,
wherein the transportation means includes belts for transporting the sheets and a plurality of rollers which have the belts hooked therearound to cause the belts to travel, and
wherein the suction means is one of the plurality of rollers that is located at the uppermost-stream side in a sheet transportation direction.

6. The sheeter apparatus according to claim 3,
wherein the suction ports are formed in parts of the outer peripheral surface of one of the rollers which no belts are hooked around.

7. The sheeter apparatus according to claim 6,
wherein the roller includes groove parts which are formed to extend in a circumferential direction of the roller, and
wherein the belts are hooked around the groove parts.

8. The sheeter apparatus according to claim 3,
wherein the roller includes: a suction path which is formed in the same direction as an axis of the roller extends, and which is connected to a suction device with a rotary joint in between; and communicating paths which communicate with the suction path, and which are connected to the respective suction ports.

9. The sheeter apparatus according to claim 1,
wherein the transportation means includes: belts for transporting the sheets; and a plurality of rollers which have the belts hooked therearound to cause the belts to travel, and
wherein the suction means is provided inside loops formed by the belts hooked around the plurality of rollers.

10. The sheeter apparatus according to claim 9,
wherein the suction means is a suction box including suction ports connected to a suction device.

11. The sheeter apparatus according to claim 1,
wherein the cutting means includes: a cut-off cylinder which is revolvably supported, and which has cutting knives; and a fixed knife, and
wherein the transported web is cut into the sheets when the cutting knives face the fixed knife with revolution of the cut-off cylinder.

12. The sheeter apparatus according to claim 1,
wherein the transportation means includes: upstream transportation means configured to transport the sheets; and downstream transportation means configured to receive the sheets from the upstream transportation means and then to transport the received sheets at a speed lower than the upstream transportation means.
